(19) United States
(12) Patent Application Publication
(10) Pub. No.: US 2011/0239229 A1
(43) Pub. Date: Sep. 29, 2011

(54) PREDICATIVE AND PERSISTENT EVENT STREAMS

(75) Inventors: Henricus Johannes Maria Meijer, Mercer Island, WA (US); Dragos A. Manolescu, Kirkland, WA (US); Brian C. Beckman, Newcastle, WA (US)

(73) Assignee: Microsoft Corporation, Redmond, WA (US)

(21) Appl. No.: 12/732,244

(22) Filed: Mar. 26, 2010

(51) Int. Cl. G06F 9/46

(52) U.S. Cl. 719/318

(57) ABSTRACT

An event driven application may predict a future event and spawn an event stream from the predicted event. The spawned event stream may be performed as a predicted operation until the prediction is confirmed to be correct or incorrect. The predicted operation may generate results that may be present when the prediction is confirmed. In some cases, the results may be used prior to the predicted event, while in other cases, the results may be cached until the prediction is confirmed. In some cases, the predicted operation may be merged with an actual event stream when the predicted event occurs. The prediction mechanism may enhance performance, enable operations that would otherwise be difficult, and may save battery life or energy in some devices.

### BACKGROUND

Event streams are common in many computer applications. An event stream may be a series of events that happen in series. Often, an event may spawn other processes or event streams. Such event streams are often processed using Complex Event Processing (CEP) systems.

### SUMMARY

An event-driven application may predict a future event and spawn an event stream from the predicted event. The spawned event stream may be performed as a predicted operation until the prediction is confirmed to be correct or incorrect. The predicted operation may generate results that may be present when the prediction is confirmed. In some cases, the results may be used prior to the predicted event, while in other cases, the results may be cached until the prediction is confirmed. In some cases, the predicted operation may be merged with an actual event stream when the predicted event occurs. The prediction mechanism may enhance performance, enable operations that would otherwise be difficult, and may save battery life or energy in some devices.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing device with a predictive event stream.

FIG. 2A is a diagram illustration of an example embodiment showing a timeline without prediction.

FIG. 2B is a diagram illustration of an example embodiment showing a timeline with prediction.

FIG. 3 is a flowchart illustration of an embodiment showing a method for managing input streams with predictions.

FIG. 4 is a flowchart illustration of an embodiment showing a method for dispositioning an incorrectly predicted task stream.

### DETAILED DESCRIPTION

A system may predict a future event from events in an event stream, then spawn a predicted event stream based on the predicted future event. The predicted event stream may be processed until the system can determine if the predicted events actually occur or not. If the predicted events occur as predicted, the predicted event stream may be converted into an actual event stream. If the predicted events do not occur, the predicted event stream may be dispositioned in different manners, such as undoing, halting, or erasing the results of the predicted event stream.

The system may be useful in situations where an event stream may be inadvertently paused or cut off, or where predicted event streams may yield increased response or performance. For example, the predicted events may be useful when a communication channel is cut off or degraded and may allow an application to continue to function. In another example, a predicted event may download information or prepare results ahead of time then have those results instantly available when the actual event occurs.

In one use scenario, a device may process an event stream in a continuous manner, such as a Global Positioning System (GPS) navigation device that updates a position on a map. The device may incur a brief interruption in the GPS signal, such as when the navigation device goes through a tunnel, for example. During the interruption, one or more predicted events may be created to represent the GPS input event stream as the device progresses through the tunnel. The predicted events may launch streams of predicted tasks, such as updating the position on the map based on information computed from the previous speed, such as the navigation speed and heading. When the device reemerges from the tunnel, the predicted event may be confirmed and the predicted event stream may be merged or consolidated with the actual event stream.

In another use scenario, a web browser may monitor input from a user, such as text input, cursor movement, or other interaction. The user input may be treated as an asynchronous event stream. Based on the user input, the web browser may predict a future event where the user may select a specific link or enter a search term. The predicted event may spawn a set of tasks that download targeted advertisements or search term information before the user actually clicks on the link or completely enters the search term. When the actual event occurs, the browser may display the downloaded information very quickly, giving a much higher performance user experience than if the information were downloaded afterwards.

In still another use scenario, a device may predict that a future event may involve downloading information across a network. While executing the tasks associated with the predicted event, the device may download the information using a slower speed and may consume less bandwidth and potentially less energy than when the device attempts to download at full speed. The lower bandwidth consumption may result in lower network costs and better bandwidth utilization, as well as potentially less energy consumption on the device.

In yet another use scenario, a device may predict that a future event may render an existing event stream useless, so the existing event stream may be terminated in response to the predicted event. For example, a wireless battery powered device may predict that a user may not view email information in the immediate future in response to an event that the user is moving rapidly, such as when the user may be driving. By avoiding email download during that time, the battery life of the wireless device may be conserved.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

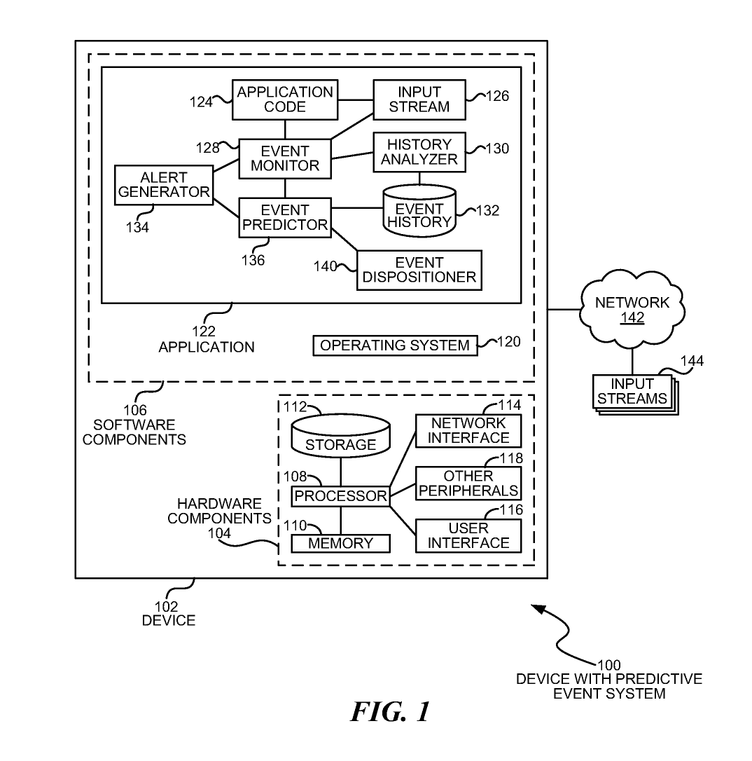

FIG. 1 is a diagram of an embodiment 100, showing a system that may use predictive events. Embodiment 100 is a simplified example of a device that may operate an application that processes event streams, and may create a predicted event that causes a series of tasks to be performed. When the prediction is shown to be true or false, the predicted event stream may be dispositioned.

The diagram of FIG. 1 illustrates functional components of a system. In some cases, the component may be a hardware component, a software component, or a combination of hardware and software. Some of the components may be application-level software, while other components may be operating-system-level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 illustrates a device that may process input streams as part of an application. An input stream may be processed by an application to produce various results. In many cases, an event in the input stream may cause an event stream to be launched, which may in turn act as events that cause other event streams to be launched.

The predicted event stream may perform various tasks in anticipation of an event occurring. In one embodiment, the predicted event stream may buffer the output from the various tasks, and when the predicted event occurs, the results of the predicted task may be immediately available. Such an embodiment may have significant performance benefits for an application.

For example, a web browser application may monitor a user's interaction with a web page on a user interface. Based on the user's interaction, a predicted event may be that the user may select a specific link to follow. While the user is viewing a web page, the predicted event may cause the web browser to begin downloading the predicted link. If the user actually selects the link, the data may be instantly available without waiting for the downloading process, since the downloading occurred prior to selecting the link.

In another embodiment, the predicted task stream may operate without buffering based on the predicted event. In another use example, a GPS receiver may display a user's position on a moving map. As the user changes position, the GPS receiver may predict where the user may move in the future and may fetch tiles for the map. If the user moves to the predicted location, the tiles may be displayed. If the user does not move to the predicted location, the tiles may be placed in a cache and may or may not be used in the future.

In a similar embodiment, the predicted task stream may operate with a lower quality of service than a regular task stream. In the example above, the GPS moving map device may download tiles in the predicted event stream at a lower resolution than a regular event stream. When the predicted event is confirmed, the low resolution tiles may be displayed while the higher resolution tiles are downloaded.

The input stream may be defined as an object whose state may be of interest. The monitor may be defined using an object that may consume the state of the input stream. One mechanism for defining such objects are the IObservable<T> and IObserver<T> constructs used in .NET framework, where IObservable<T> may be used to represent an input event stream and IObserver<T> may be used to represent the monitoring object. Other frameworks may have similar constructs that may use a subject/observer or Model-View-Controller design pattern.

The system for processing the input stream may fall into the category of Complex Event Processing (CEP) of computer science.

While observing the input stream, a monitor may launch other event streams in response to different events. An output stream may be the aggregate of several event streams that spawn from monitored events. The output stream may be the result of a bind operation performed on one or more event streams, which may or may not include the predicted event stream.

Because an input stream may be treated as an asynchronous stream of events, application code may be capable of responding to a predicted event in the same manner as an actual event. An event predictor may create a predicted event an insert the predicted event into an input event stream, so that the application code may process the predicted event as if the predicted event were an actual event.

The application code may react to the predicted event by creating a separate event stream, which may include various tasks that the application may perform. Each task may be an event on the predicted event stream.

The predicted event may be handled differently from an actual event because when the prediction is incorrect, the response to the predicted event may be undone, cleaned up, ignored, halted, or otherwise corrected. When the predicted event was correctly predicted, the response may yield a performance benefit to the application.

In many embodiments, a ‘correct’ prediction may be any prediction that is within a tolerance range. Some predicted events may be close to the actual event and may be adjusted or corrected after the actual event occurs. In some cases, a close predicted event may be sufficient for the application to continue even if the predicted event did not exactly match the actual event.

In some embodiments, the predicted event may be processed in a ‘sandbox’ or specialized mode. In such a mode, the event stream spawned by a predicted event may be cashed, buffered, or separated from a normal resulting event stream so that the predicted event stream may be deleted or removed when the prediction was incorrect. In the case that the prediction was correct, the predicted event stream may be merged or converted into a regular event stream, or the cached or buffered results may be released to be used immediately.

In other embodiments, the predicted event stream may operate as a normal event stream without special handling, and may generate results that are further processed by the application and may or may not be made visible to a user. In such an embodiment, the predicted event stream may be halted if the prediction is determined to be untrue. Such an embodiment may be useful when the results of a predicted event are benign.

The device 102 may represent a conventional computer device on which an application with predictive event processing may operate. The device 102 is illustrated as a standalone device that may process an input stream, and may reflect a desktop computer, server computer, game console, network appliance, or other device. In some embodiments, the device 102 may be a portable device, such as a laptop computer, netbook computer, mobile telephone, handheld personal digital assistant, portable barcode scanner, portable GPS receiver device, or other type of device.

In some embodiments, the functional components of the device 102 may be performed by different devices connected using a network. In some such embodiments, various portions of the functions described may be performed by network servers, for example, while other portions may be performed by a client device.

The device 102 may have various hardware components 104 and software components 106. The architecture illustrated may represent a conventional computer device, although other architectures may be used in other embodiments.

The hardware components 104 may include a processor 108 that may use random access memory 110 and nonvolatile storage 112. The hardware components may include a network interface 114 and a user interface 116. In some cases, the hardware components 104 may include other peripherals 118, such as Global Positioning System (GPS) receivers, instrumentation, or other peripherals.

The software components 106 may include an operating system 120 on which various applications 122 may execute.

The applications 122 may be any type of application that may perform any type of function. In some cases, the applications 122 may perform functions with which a user may interact. Many such applications may present a user interface to a user and receive input from the user. Other applications may process information without user interaction, and may operate using an application programming interface (API), for example.

The applications 122 may have application code 124 that may process an input stream 126. The input stream 126 may be defined as a container object that contains instances of events. The events may be defined by a data type and may be produced by an outside source, such as user interaction or input from a data source, such as a GPS receiver. In some embodiments, the applications 122 may process many different event streams. The input stream 126 may be an asynchronous event stream, where the application code 124 may be capable of processing the input events as the event occur, as opposed to processing the input events at predefined intervals.

An event monitor 128 may monitor the input stream 126 and identify events to process by the application code 124. In response to an event in the input stream 126, the application code 124 may perform various actions in response. The actions may be treated as another event stream.

A history analyzer 130 may analyze input stream 126 to generate an event history 132. The event history 132 may contain event histories from many event streams in some embodiments, including event streams collected by the device 102 as well as other devices.

Using the GPS map device as an example, the event streams from many different users may be used to build a history of paths that the users followed with their devices. The paths are event streams containing positions where the devices were located. Such a history may also include previous paths that the device 102 has created.

The various histories may be used to predict a future event by an event predictor 136. The event predictor 136 may identify a predicted future event and cause an event stream to be created from the predicted event. An illustrated example may be found in the discussion of embodiment 200 presented later in this specification.

The event predictor 136 may create a predicted event, then insert the predicted event into the input stream 126. The application code 124 may process the predicted event as if the predicted event were an actual event. In some cases, the application code 124 may handle the predicted event in a different manner as an actual event, such as performing responses in a protected or cached mode, as well as other manners.

The events in the input stream 126 may be asynchronous, meaning that the events are not relegated to a specific interval and may occur at any time. In many cases, such as the GPS receiver input example, the updated GPS position may be updated on a regular basis, however, the application code 124 may be designed to handle the GPS location events as asynchronous events.

An event dispositioner 140 may handle the predicted event stream once an outcome of a prediction is known. In the case of a correctly predicted event, the event dispositioner 140 may change the classification of a predicted event stream from a predicted event stream to a regular event stream. In embodiments where the predicted event stream does not have a separate classification, the event dispositioner may not perform any action and merely allow the predicted event stream to continue.

In the case of an incorrectly predicted event, the event dispositioner 140 may clean up the effects of a predicted event stream. For example, the event dispositioner 140 may halt the predicted event stream, create a set of anti-events to undo the actions of the predicted event stream, and then execute the anti-events.

In the case where a predicted event stream has results that are placed in a buffer or cache, the event dispositioner 140 may cause the buffer or cache to be flushed after stopping the predicted event stream.

In some embodiments, the event dispositioner 140 may merely cause a predicted event stream to halt any future operations when the prediction is determined to be incorrect. When no future operations exist, the event dispositioner 140 may not perform any action in some cases.

An alert generator 134 may be used to launch an event predictor 136 in some embodiments. The alert generator 134 may identify a break in an input stream and cause the event predictor 136 to generate a predicted event to supplement an interruption in an input stream. Using the example of a GPS enabled device above, the alert generator 134 may sense a break in a GPS input stream when the device enters a tunnel. In response to the detection, the alert generator 134 may cause the event predictor 136 to generate one or more predicted events and insert the predicted events into the input stream 126 so that the GPS device may continue to show the location.

In some embodiments, the event predictor 136 may operate continually and may attempt to predict future input so that the application 122 may have increased performance.

The event predictor 136 may use event history 132 as well as other context information to generate one or more predicted events. The event history 132 may be derived from previous input streams 126, including input streams that the device 102 has processed as well as similar input streams processed by other devices. Other input streams 144 may be received over a network 142 and processed by the history analyzer 130 to generate an event history 132. In some embodiments, the event history 132 may be received from a remote server that may process many different input streams, such as the input streams from multiple devices.

The event predictor 136 may detect a series of events on the input stream 126. In a simple example using the GPS enabled device, the events indicating that a user has progressed along a highway over a period of time may be used to predict that the user may progress at the same speed along the same highway.

The event predictor 136 may also use additional information to perform a prediction. The additional information is referred to as ‘context’. Context may be any other information in addition to the events in an input stream. A simple example of context may be a time of day input.

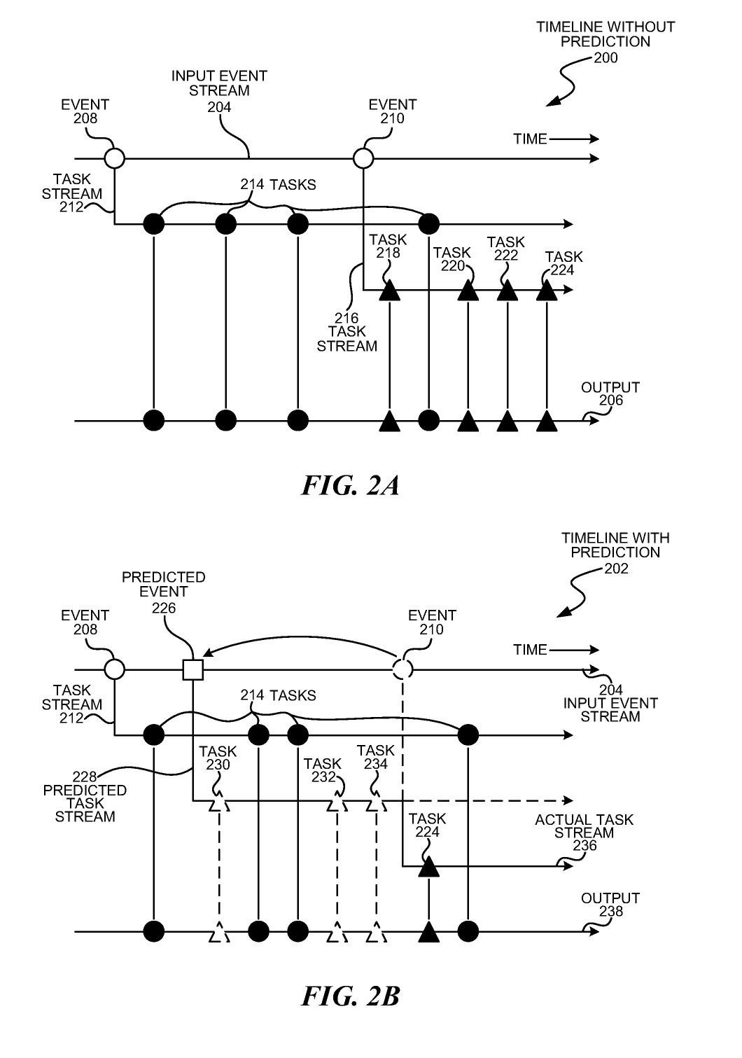

FIGS. 2A and 2B are diagram illustrations showing timelines with and without predicted events. Embodiment 200 is illustrated in FIG. 2A as a timeline without a prediction, and embodiment 202 is illustrated in FIG. 2B as the same timeline but with a predicted event.

In embodiment 200, an input event stream 204 is illustrated along with an output event stream 206. A complex event processing system may receive the input events, process those events, and create output events from various tasks. The input event stream may be represented as an IObservable<T> object in the .NET framework, or as a similar design pattern in other computing frameworks.

The event 208 may cause a task stream 212 to be performed. Along the task stream 212, various tasks 214 may be performed and may be exposed as events on the task stream 212. The output event stream 206 may be illustrated as a bind operation for the various task streams, and the events from task stream 212 are illustrated as being exposed on the output task stream 206.

The event 210 may be encountered later in time from event 208, and may cause task stream 216 to be performed. Task stream 216 may consist of tasks 218, 220, 222 and 224, which may be exposed as events and bound to the output event stream 206.

The operations of embodiment 200 represent an application operation that may be performed without prediction. In other words, each event on an input stream 204 may cause an associated task stream to be performed, which may generate events that are bound to an output stream.

Compare embodiment 200 to embodiment 202, where the same process may be performed with a prediction.

Embodiment 202 illustrates the input event stream 204 with events 208 and 210. Event 208 is illustrated as occurring in the same manner as embodiment 200, with the task stream 212 and tasks 214.

Embodiment 202 includes a predicted event 226, which may be a predicted version of event 210. The predicted event may be created by a prediction algorithm and inserted into the input event stream 204. In response to the predicted event 226, a predicted task stream 228 may be created.

The predicted task stream 228 may include tasks 230, 232, and 234, which may correspond with the tasks 218, 220, and 222 of embodiment 200. The results or events from the predicted tasks may be bound to the output event stream 238. When the event 210 actually occurs as predicted, the predicted task stream 228 may be changed to an actual task stream 236, which may include task 224.

In some embodiments, the output of the predicted tasks 230, 232, and 234 may be buffered or cached and not bound to the output event stream 238. In some embodiments, the operations of predicted tasks 230, 232, and 234 may be performed at a lower quality of service level than normal tasks. For example, an image download during a lower quality of service level may be performed at a lower resolution than during a high quality of service level task.

The results of the predicted event are illustrated in comparing the output event streams 206 and 238. When the predicted event is used, many of the tasks can be performed quickly. The predicted tasks 230, 232, and 234 may be completed even before the predicted event occurs, leaving only the task 224 to be performed after the event 210 occurs. This may increase performance of an application dramatically, as there are only two tasks remaining after event 210 in embodiment 202, but five tasks remaining after event 210 in embodiment 200.

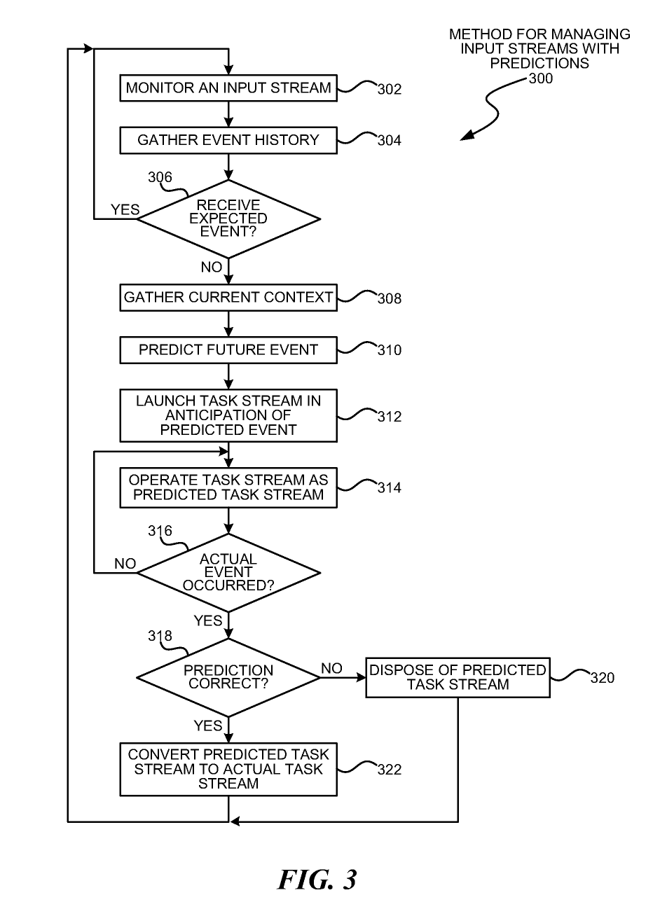

FIG. 3 is a flowchart illustration of an embodiment 300 showing a method for managing input streams with predictions. Embodiment 300 is a simplified example of the processes that may be performed by an application in response to an input stream.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 illustrates an example operation that may be performed for predicting an event. Embodiment 300 monitors in input event stream and if the event stream is interrupted, a prediction mechanism is engaged to predict events to fill in during the interruption.

Other embodiments may create predicted events based on other criteria. In some embodiments, a prediction mechanism may be continually engaged. In such an embodiment, the prediction mechanism may serve to enhance performance of an application or device.

In block 302, an input event stream may be monitored. In many computer languages that have complex event processing, an object may be defined that contains events of a specific type. Other objects may be defined that may subscribe or monitor those events. In some cases, the monitoring object may have a filter or other definition that allows the monitoring object to select certain events from the input event stream.

In a .NET framework, an input event stream may be represented by an IObservable<T> object and a monitor may be presented by an IObserver<T> object. Other frameworks may have similar constructs.

In block 304, event history may be monitored. The event history may be a succession of events. In block 306, if an expected event is received, the process may return to block 302. If an expected event is not received in block 306, the process may proceed to block 308.

A current context may be gathered in block 308. The event history along with the current context may be used to predict a future event in block 310. Each application may have different criteria and use different parameters for predicting events. In some applications, an event may be predicted using formulas, heuristics, or other mechanisms that may predict events in different manners.

Based on the predicted future event from block 310, a task stream may be launched in block 312 in response. The task stream may have several tasks that an application may perform, and those tasks may be exposed as events for an output event stream.

The task stream may be operated in block 314, and may loop back through block 316 until an actual event occurs. The determination of an actual event in block 316 may vary with each application. In some cases, another event may occur that may indicate that the prediction was incorrect, even when the predicted event was predicted for a later time. Each application may have different mechanisms and different thresholds for determining the potential correctness or incorrectness of a prediction.

If the prediction is not correct in block 318, the predicted task stream may be disposed of in block 320. An example of a disposition mechanism may be illustrated in embodiment 400 presented later in this specification.

If the prediction is correct in block 318, the predicted task stream may be converted to an actual task stream in block 322. In some embodiments, output from a predicted task stream may be buffered or cached. In such embodiments, the results stored in the buffer or cache may be released in block 322 for use.

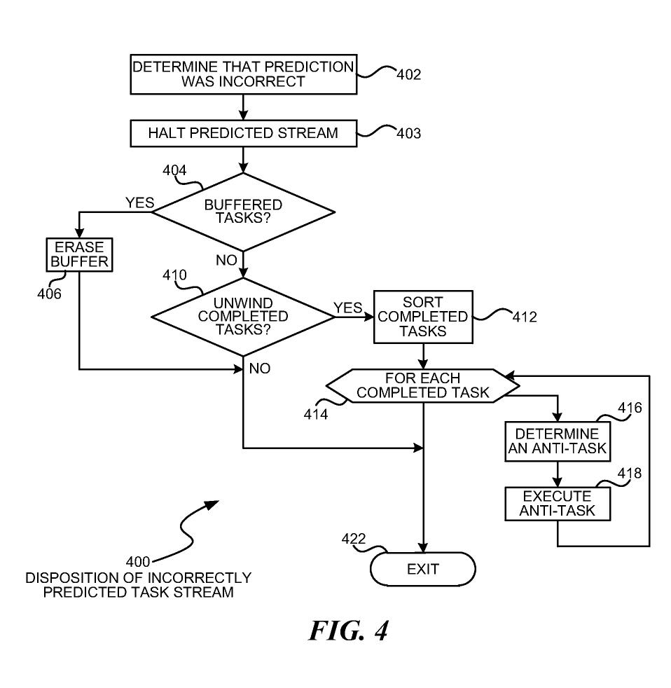

FIG. 4 is a flowchart illustration of an embodiment 400 showing a method for dispositioning incorrectly predicted task streams. Embodiment 400 is a simplified example of the processes that may be performed when a prediction is incorrect, such as the operations of block 320 of embodiment 300.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 illustrates a generic process that highlights different mechanisms for dispositioning the results of a predicted task stream when the prediction is found to be incorrect.

In some cases, a predicted event stream may spawn many event streams. For example, a task performed in an original predicted event stream may expose an event that may be consumed by another observer object and launch another event stream. This may happen many times, creating a chain of events and event streams that may be cleaned up if the prediction is found to be incorrect.

In block 402, a prediction may be found to be incorrect. Block 402 may correspond with block 318 of embodiment 300. When the prediction is found to be incorrect in block 402, the predicted event stream may be halted in block 403.

In many embodiments, a predicted event may not exactly match an actual event. In such cases, the predicted event may be determined to be ‘correct’ when the predicted event is within a predefined range of values. The predicted event may be considered ‘correct’ when the predicted event is equivalent modulo a predefined equivalence relation.

If the output of the tasks is buffered in block 404, the buffer may be erased in block 406 and the process may end in block 422. In such a case, the effects of a predicted task stream may not have been incorporated into an output event stream.

If the output has not been buffered in block 404 and the completed tasks are not to be unwound in block 410, the process may end in block 422. In such a case, the output of the predicted event stream may be benign, such as having downloaded information in anticipation of an event. When the event does not occur, the downloaded information may be ignored.

When the completed tasks are to be unwound in block 410, the completed tasks may be undone. In a simple case, each of the completed tasks may be undone. In more complex cases where other event streams have spawned from the predicted tasks, the list of tasks may be extensive.

The tasks may be sorted in block 412 in preparation for undoing the predicted tasks. In some cases, the tasks may be undone in the order of the original tasks, while in other cases the task may be undone in reverse order. The actual order may depend on the type of tasks and the specific application. In some cases, a sequence of completely different tasks may be executed, where the sequence compensates for the actions of the predicted tasks.

Each of the completed tasks may be analyzed in block 414. For each task in block 414, an anti-task may be created in block 416 and executed in block 418. An anti-task may perform the opposite of the original task, undo the operations of the original task, or otherwise re-create the environment prior to the completed task.

In some embodiments, a predicted task stream may be dispositioned by a combination of the methods described in embodiment 400. For example, some tasks may be ignored, those tasks that are buffered may have the buffer purged, while other tasks for which an anti-task is available may be corrected using an anti-task.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on a computer processor, said method comprising:
monitoring an input stream comprising a series of asynchronous events, said monitoring being performed by an observer object, said series of asynchronous events being defined by a collection of asynchronous events, said collection having a data type to which said asynchronous events conform;
determining a history of events from said input stream;
spawning a first event stream in response to a first event in said input event stream, said first event stream comprising a plurality of events;
determining a predicted future event based on said history of events and said current context;
spawning a predicted event stream in response to said predicted future event, said predicted event stream comprising predicted tasks to perform, said predicted tasks being one event on said predicted event stream;
performing a plurality of said predicted tasks in said predicted event stream prior to determining an actual outcome for said future event;
binding said predicted event stream and said first event stream into an output stream; and
dispositioning said predicted task stream based on said actual outcome.

2. The method of claim 1 further comprising:
determining that said actual outcome was equivalent to said predicted event; and
converting said predicted event stream to a regular event stream.

3. The method of claim 2, said predicted event stream comprising events performed at a lower quality of service than said regular event stream.

4. The method of claim 1 further comprising:
determining that said actual outcome was not equivalent to said predicted event and in response:
halting said predicted event stream;
creating an anti-event for each of said predicted tasks performed in said predicted event stream; and
performing each anti-event, said anti-event being bound to said output event stream.

5. The method of claim 1 further comprising:
determining a current context for said series of events; and
said predicted future event being predicted additionally based on said current context.

6. The method of claim 5, said history of events comprising a history from a plurality of input streams each from a different user.

7. The method of claim 6, said context comprising parameters values describing a current situation.

8. The method of claim 1, said predicted event stream comprising terminating said first event stream.

9. The method of claim 8 further comprising:
determining that said actual outcome was not equivalent to said predicted event and resuming said first event stream.

10. The method of claim 1 further comprising:
identifying an expected event in said input stream, said expected event being identified from said history of events;
determining that said expected event has not occurred; and
causing said predicted event to be determined based on said expected event having not occurred.

11. The method of claim 10, said expected event comprising an interruption to said input stream.

12. The method of claim 1, said predicted event stream being buffered from being bound into said output stream until said actual outcome is determined.

13. The method of claim 12 further comprising:
determining that said actual outcome was equivalent to said predicted event and unbuffering said predicted event stream.

14. A system comprising:
a processor;
an input event monitor that monitors an input stream comprising a series of asynchronous events, said monitoring being performed by an observer object, said series of asynchronous events being defined by a collection of asynchronous events, said collection having a data type to which said asynchronous events conform;
an event predictor that:
predicts a future event and launches a predicted event stream comprising a plurality of tasks to execute in response to said future event; and
binds said predicted event stream into an output stream;
an event dispositioner that:
determines an actual outcome for said event; and
disposes said predicted task stream based on said actual outcome.

15. The system of claim 14, said input event monitor that further:
detects that said series of input events has been interrupted; and
causes said event predictor to perform said predicting.

16. The system of claim 14, said event predictor predicting said future event based in part on a history of events collected from said input event monitor.

17. A method performed on a computer processor, said method comprising:
monitoring an input stream comprising a series of asynchronous events, said monitoring being performed by an observer object, said series of asynchronous events being defined by a collection of asynchronous events, said collection having a data type to which said asynchronous events conform;
determining a history of events from said input stream and at least one other event stream;
spawning a first event stream in response to a first event in said input event stream, said first event stream comprising a plurality of events;
determining a current context for said series of events;
determining a predicted future event based on said history of events and said current context;
spawning a first predicted event stream in response to said first predicted future event, said first predicted event stream comprising predicted tasks to perform, said predicted tasks being one event on said predicted event stream;
performing a first predicted task in said predicted event stream prior to determining an actual outcome for said future event;
spawning a second predicted event stream in response to said first predicted task;
binding said first predicted event stream, said second predicted event stream, and said first event stream into an output stream; and
dispositioning said predicted task stream based on said actual outcome.

18. The method of claim 17 further comprising:
determining that said actual outcome was equivalent to said predicted event;
converting said first predicted event stream to a regular event stream; and
converting said second predicted event stream to a regular event stream.

19. The method of claim 18, said first predicted event stream comprising events performed at a lower quality of service than said regular event stream.

20. The method of claim 17 further comprising:
determining that said actual outcome was not equivalent to said predicted event and in response:
halting said predicted event stream;
creating an anti-event for each of said predicted tasks performed in said first predicted event stream and said second predicted event stream; and
performing each anti-event, said anti-event being bound to said output event stream.
